(19) United States
(12) Patent Application Publication
(10) Pub. No.: US 2018/0086554 A1
(43) Pub. Date: Mar. 29, 2018

(54) Variable-Gauge Plastic Drawstring Bag

(71) Applicant: API Industries, Inc., Orangeburg, NY (US)

(72) Inventor: David Anderson, Montvale, NJ (US)

(21) Appl. No.: 15/458,479

(22) Filed: Mar. 14, 2017

Related U.S. Application Data
(60) Provisional application No. 62/400,779, filed on Sep. 28, 2016.

(51) Int. Cl. B65F 1/00; B29C 47/00; B29C 47/20

(52) U.S. Cl. CPC B65F 1/002; B29C 47/0026; B29L 2031/7128; B65F 2250/1143; B29K 2023/06; B29C 47/20

(57) ABSTRACT

Described is a plastic bag having a top portion with a top thickness, a center portion with a center thickness and a bottom portion with a bottom thickness. The top portion has an opening and a drawstring running therethrough. The top thickness is approximately equal to the bottom thickness. The center thickness is less than the top thickness and the bottom thickness.

### REFERENCE TO PRIOR APPLICATIONS

This application claims the benefit of U.S. Provisional Patent Application 62/400,779, filed Sep. 28, 2016.

### FIELD OF THE DISCLOSURE

The present disclosure relates generally to an improved drawstring plastic garbage bag with variable-gauge plastic.

### BACKGROUND

Plastic bags are a convenient and sanitary way of handling garbage, and are widely used. Plastic garbage bags are fairly lightweight and are particularly useful for messy or wet rubbish, as is commonly the case with food waste, and are also useful for wrapping up garbage to minimize odor. Plastic bags are often used for lining litter or waste containers or bins. This serves to keep the container sanitary by avoiding container contact with the garbage. After the bag in the container is filled with litter, the bag can be pulled out by its edges, closed, and tied with minimal contact with the waste matter.

Plastic bags may also include conventional or elastic drawstrings that are enclosed in the hems at the top of the plastic bag which can be used to both hold the top of the bag on the top of a receptacle as well as to close the bag when filled. The closed loop elastic drawstring may be used as a tie strip to close the bag when it is removed from the receptacle. The drawstring provides both a holding force for maintaining the bag in the receptacle and a tie string for closing the bag when removed from the receptacle.

Traditionally, while the gauge (thickness) of the plastic drawstring bag has been uniform, there may be advantages to varying the gauge of the plastic drawstring bag in various places. The standard manufacturing process of garbage bag plastic may be adjusted to allow for the variable thickness of the plastic.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a drawing of a variable-gauge drawstring plastic garbage bag in accordance with some embodiments.

FIG. 2 is a schematic view of a variable-gauge plastic film web in accordance with some embodiments.

FIG. 3 is schematic view of a die cross-section for plastic extrusion of variable-gauge plastic in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The solution described herein has properties that may be used in combination or separately.

Plastic trash bags are generally made from granules of linear polyethylene resin that is melted. During melting, the linear polyethylene resin is blended with a low density polyethylene in a mixer. The granules melt in an extruder, which heats the granules to approximately 350-450 degrees F.

As the molten material is pushed into and through the extrusion die, a plastic film tube emerges from the outlet of the extrusion die. The plastic film tube is blown or expanded to a larger diameter by providing a volume of air within the interior of the plastic film tube. The combination of the volume of air and the plastic film tube is commonly referred to as a bubble between the extrusion die and a set of nip rollers. The plastic film tube is commonly cooled by one or more external air rings applying a constant flow of air upward along the outside of the plastic film tube. A number of factors including, but not limited to, the air pressure within the bubble of the plastic film tube, the cooling rate provided by the air ring, the temperature and flow of material out of the extrusion die, and the rate at which the plastic film tube is pulled by the nip rollers impact the blow-up ratio, diameter of the plastic film tube, and the ultimate thickness or gauge of the plastic film tube.

As the plastic film tube cools travelling upward toward the nip rollers, the plastic film tube solidifies from a molten state to a solid state after it expands to its final diameter and thickness. The point along the bubble where the plastic film solidifies is known as the frost line. Consequently, the portion of the bubble below the frost line is molten allowing for expansion and thinning of the plastic film tube. Conversely, the portion of the bubble above the frost line has solidified and the diameter and thickness of the plastic film tube is generally fixed at that point.

This process produces a film of polyethylene in the form of a long tube which eventually cools down. Rollers then flatten out the plastic tube so that the polyethylene can be cut into the required width and length.

In most cases, plastic garbage bags are fabricated using one piece of polyethylene that is double the height of the completed garbage bag. This double-height polyethylene piece is folded in half so that the height of the now-folded piece is the height of the completed garbage bag. The sides of the now-folded piece are fused together, leaving an opening at the top of the now-created bag. Hems are created on both sides of the top opening and a drawstring is run through both hems. The hems are then fused to the top part of the bag, securing the drawstring. Cutouts are usually created in the center of both hems so that the user can pull the drawstring out from both hems and tie the it closed, this securing the contents of the trash bag.

Traditional plastic garbage bags have always used a single gauge thickness for the film web that makes the bag. But significant advantages arise from using multiple-gauge thickness, as is described further herein.

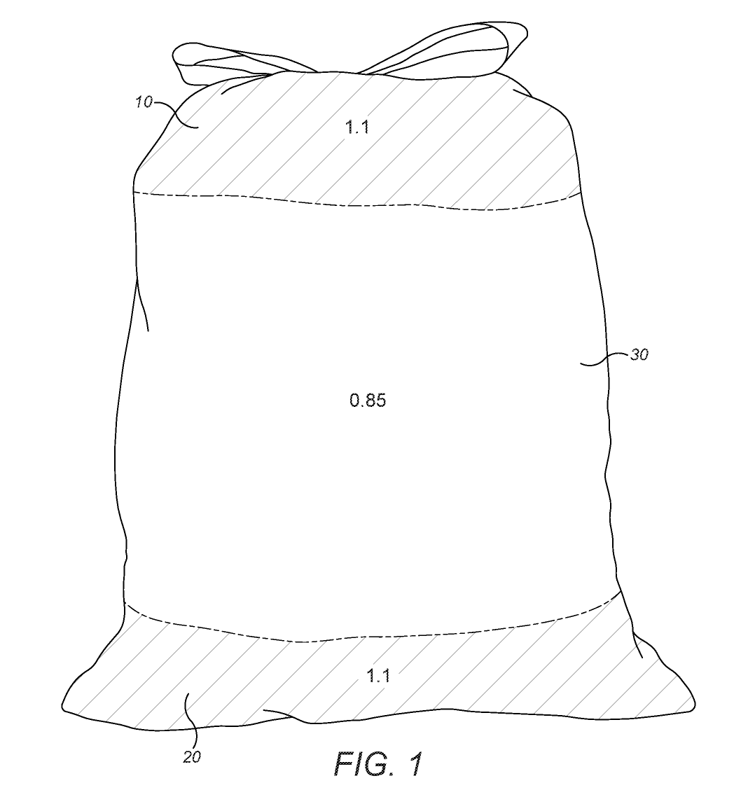

Shown in FIG. 1 is a diagram of a plastic drawstring bag with variable gauge in its construction. The highlighted top portion 10 and highlighted bottom portion 20 may be made of a gauge of approximately 1.1 mil (1 mil is 1/1000 of an inch). The central portion 30 may be made of a thinner gauge of 0.85 mil. The gauges were indicated for illustration purposes and other thicker or thinner gauges may be use as well.

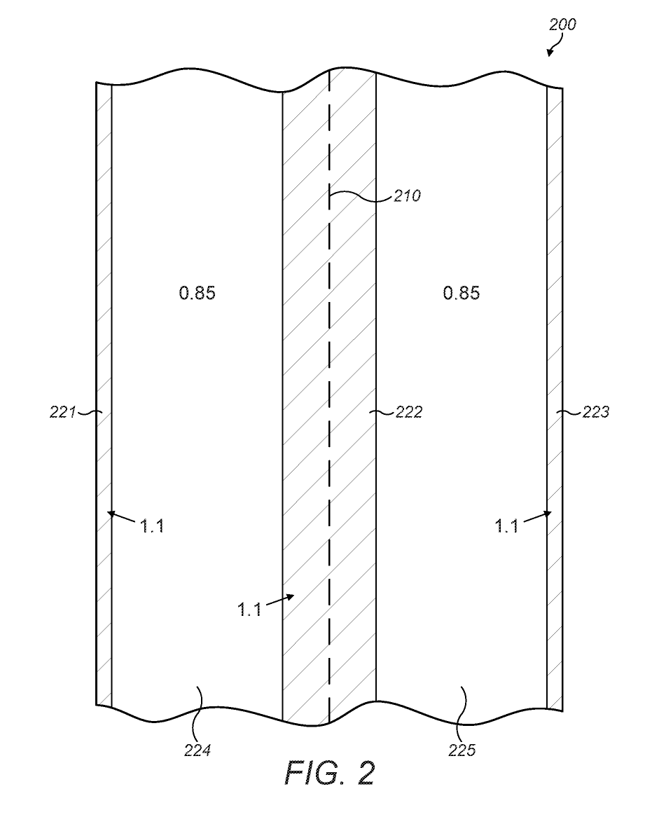

Shown in FIG. 2 is a schematic 200 of the film web that can be used to manufacture the variable-gauge drawstring bag. The film is used to produce 2 drawstring bags that are symmetrically opposite about the center axis 210. Thus, the thicker gauge (which may be 1.1 mil) that will eventually be part of the bottom of first bag and the top of the second bag may be found in the center portion 222 of the film web. The thicker gauge that may be found on the top of the first bag may be found on the left portion 221 of the film web. The thicker gauge that may be found on the bottom of the second bag may be found on the right portion 223 of the film web 200. Because the center portion 222 covers the thicker gauge portions of 2 bags, it is a necessarily larger portion than the left portion 221 and right portion 223 of the film web. The remaining portions of the film 224, 225 may be made of a thinner gauge such as 0.85 mil. These portions will form the center portions of each of the two bags from the film web.

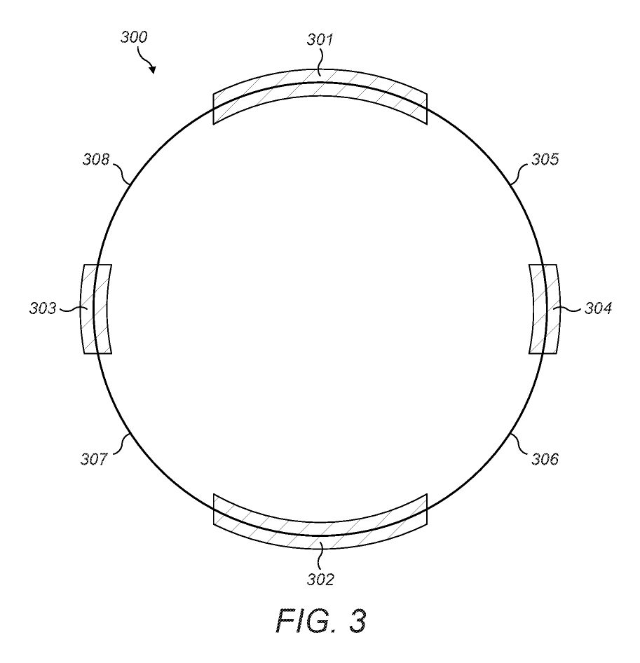

Shown in FIG. 3 is a cross-section die view 300 that may be optionally used instead of a standard annular die for plastic extrusion that corresponds to the film web 200. The objective of such an extrusion die may be to distribute the polymer melt in the flow channel such that the material exits from the die with a uniform velocity.

The highlighted longer portions 301, 302 correspond to the larger center portion 222 for the thicker gauge of the film web 200. The highlighted shorter portions 303, 304 correspond to the shorter left portion 221 and right portion 223 for the thicker gauge of the film web 200. The remaining un-highlighted potions 305, 306, 307, 908 of the die view 300 correspond to the portions of the film 224, 225 made of a thinner gauge.

An alternative method for creating the variable-gauge plastic bag is by varying the air cooling rate of the film in specific areas. Modifications to the cooling rates of the polymer may be made within the air ring to created thicker and thinner portions of the bag. A thicker film and gauge will result in those areas where more cooling is applied to the film. A thinner film and gauge will result in those areas where less cooling is applied to the film. The variable air cooling may be accomplished by adjusting a bubble cooling air ring. This alternative method may be used in conjunction with, or in place of, the variable die method shown in FIG. 3.

The variable-gauge plastic bag allows the bag to be reinforced in the areas where the bag is subject to the most stress: the top where the plastic is subject to being pulled by a user when the bag is lifted and the bottom where the plastic is subject to the weight of the garbage in the bag. The areas that do not experience as much stress (the center of the bag) can be made of thinner material. This allows for a more efficient allocation of plastic and a cheaper bag overall as well as allowing the bags to expand more easily in the middle section to accommodate more contents.

Although the values of 1.1 mil for the thicker portion of the bag and 0.85 mil for the thinner portion of the bag are used herein, other values may be used to produce similar results.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. An apparatus comprising:
a plastic bag having a top portion with a top thickness, a center portion with a center thickness and a bottom portion with a bottom thickness;
wherein the top portion has an opening and a drawstring running therethrough;
wherein the top thickness is approximately equal to the bottom thickness; and
wherein the center thickness is less than the top thickness and the bottom thickness.

2. The apparatus as in claim 1, wherein the top portion has a top height, the center portion has a center height, and the bottom portion has a bottom height;
wherein the top height is approximately equal to the bottom height; and
wherein the center height is larger than the top height and the bottom height.

3. The apparatus as in claim 2, wherein the top thickness and the bottom thickness are approximately 1.1 mil and the center thickness is approximately 0.85 mil.

4. The apparatus as in claim 2, wherein the center portion expands at a greater rate than the top portion and the bottom portion.

5. An apparatus comprising:
a plastic sheet having a left portion with a left thickness and a left length, a left-center portion with a left-center thickness and a left-center length, a center portion with a center thickness and a center length, a right-center portion with a right-center thickness and a right-center length, and a right portion with a right thickness and a right length;
wherein the left-center thickness and the right-center thickness are approximately equal;
wherein the left thickness, the center thickness, and the right thickness are approximately equal; and
wherein the left-center thickness and the right-center thickness are less than the left thickness, the center thickness and the right thickness.

6. The apparatus as in claim 5,
wherein the left length and the right length are approximately equal;
wherein the left-center length and the right-center length are approximately equal;
wherein the left-center length and the right-center length are larger than the center length; and
wherein the center length is larger than the left length and the right length.

7. The apparatus as in claim 6, wherein the center length is approximately equal to the sum of the left length and the right length.

8. The apparatus as in claim 7, wherein the left thickness, the center thickness and the right thickness are approximately 1.1 mil and wherein the left-center thickness and the right-center thickness are approximately 0.85 mil.

9. The apparatus as in claim 7, wherein the plastic sheet is formed using air cooling and wherein the left portion, the center portion and the right portion are produced using a process of applying more air cooling to those portions of a plastic film that correspond to the left portion, the center portion and the right portion.

10. The apparatus as in claim 7, wherein the plastic sheet is formed using air cooling and wherein the left-center portion and the right-center portion are produced using a process of applying less air cooling to those portions of a plastic film that correspond to the left-center portion and the right-center portion.

11. A method comprising:
a) extruding polyethylene using a die, wherein a cross-section of the die has an approximately circular shape with first large opening section, a second large opening section, a third large opening section, a fourth large opening section, a first small opening section, a second small opening section, a third small opening section, and a fourth small opening section;
wherein the first small opening section is between the fourth large opening section and the first large opening section, the second small opening section is between the first large opening section and the second large opening section, the third small opening section is between the second large opening section and the third large opening section, and the fourth small opening section is between the third large opening section and the fourth large opening section;
b) producing a plastic sheet from the polyethylene having a left portion with a left thickness and a left length, a left-center portion with a left-center thickness and a left-center length, a center portion with a center thickness and a center length, a right-center portion with a right-center thickness and a right-center length, and a right portion with a right thickness and a right length;
wherein the left portion results from extrusion through the first larger opening section, the left-center portion results from extrusion through the first smaller opening and the third smaller opening, the center portion results from extrusion through the second large opening section and the fourth large opening section, the right-center portion results from extrusion through the second small opening and the fourth small opening, and the right portion results from extrusion through the third large opening section.

12. The method as in claim 11, wherein the left length and the right length are approximately equal;
wherein the left-center length and the right-center length are approximately equal;
wherein the left-center length and the right-center length are larger than the center length; and
wherein the center length is larger than the left length and the right length.

13. The apparatus as in claim 12, wherein the center length is approximately equal to the sum of the left length and the right length.

14. The apparatus as in claim 13, wherein the left thickness, the center thickness and the right thickness are approximately 0.85 mil and wherein the left-center thickness and the right-center thickness are approximately 1.1 mil.
